(19) United States
(12) Patent Application Publication
(10) Pub. No.: US 2021/0194242 A1
(43) Pub. Date: Jun. 24, 2021

(54) HAZARDOUS VOLTAGE PRE-CHARGING AND DISCHARGING SYSTEM AND METHOD

(71) Applicant: MAGNA INTERNATIONAL INC., Aurora (CA)

(72) Inventors: Andreas EGLSEER, Behamberg (AT); Martin WINTER, Dietach (AT)

(21) Appl. No.: 17/271,876

(22) PCT Filed: Aug. 30, 2019
(86) PCT No.: PCT/CA2019/051214

§ 371 Date: Feb. 26, 2021

Related U.S. Application Data
(60) Provisional application No. 62/725,399, filed on Aug. 31, 2018.

(51) Int. Cl. H02H 7/20; B60L 50/60; B60L 53/00

(52) U.S. Cl. CPC H02H 7/20; B60L 53/00; B60L 50/60

(57) ABSTRACT

A system for pre-charging and discharging a hazardous voltage direct current system includes a first relay in the form of main contactors, a second relay, and a resistor disposed between first and second electrical contacts. In an initial state, the main contactors are open, and the second relay connects the resistor to the second contacts to operate as a passive discharge. In a startup state, the second relay is switched and pre-charging occurs with the resistor. In an operating state, the main contactors are closed and current flows between the first and second contacts without the resistor. In a shutdown state, the main contactors are opened and the second relay is switched to connect the resistor to the second contacts, and voltage from the second contacts is discharged thermally at the resistor.

### CROSS-REFERENCE TO RELATED APPLICATION

This PCT International Patent application claims the benefit of and priority to U.S. Provisional Patent Application Ser. No. 62/725,399 filed on Aug. 31, 2018, titled “High Voltage Pre-Charging And Discharging System And Method,” the entire disclosure of which is hereby incorporated by reference.

### TECHNICAL FIELD

The present disclosure relates to hazardous voltage direct current systems in electric vehicles. More particularly, the present disclosure relates to a unit that pre-charges the system and also discharges the voltage in the system.

### BACKGROUND OF THE DISCLOSURE

Electric passenger vehicles, such as purely electric or hybrid electric vehicles are in common use in the passenger vehicle industry as well as the commercial vehicle industry (such as trucks and buses). Electric vehicles rely on hazardous voltage direct current (HVDC) in their use. Hazardous-voltage systems with a large capacitive load can be exposed to high electric current during initial turn-on. Unlike some HVDC applications, which may be turned on in rare occasions such as initial power up of utility power distribution, HVDC systems for electric vehicles require a power up frequently. In most electric vehicle systems, the HVDC system is powered up multiple times per day.

Thus, it is desirable to pre-charge the powerline voltages of a HVDC system during an initial power on to limit the inrush current during the power up procedure. Without pre-charging, the peak inrush current at power-up can stress the electric components of the system, thereby reducing its reliability and life-span. Pre-charging the system can increase the lifespan and reliability of the components in a high-voltage system.

In electric vehicles, pre-charging resistors in the system is necessary in order to avoid charging the capacitors in the system with the peak inrush current, and to avoid damaging the wiring, relays, battery, or fuses. However, electric vehicle standards also require that the HVDC circuit be free of voltage within a short time after it has been switched off.

Prior electric vehicle systems utilize two separate functional elements to achieve the requirements of pre-charging the system at power up and discharging the voltage in the system after shutdown. Each functional element forms one relay and one resistor.

In view of the foregoing, there remains a need for improvements to pre-charging and discharge units.

### SUMMARY OF THE INVENTION

A circuit for pre-charging and discharging a hazardous voltage direct current system includes a pair of first electric contacts connected to a pair of second electric contacts via first and second lines; a first relay in the form of main contactors disposed on the first and second lines having an open state that breaks a connection between the first and second contacts and a closed state that makes the connection between the first and second contacts, and a partially open state that makes a connection along the first line and breaks a connection along the second line; a first bypass line extending from the first line at a point disposed between the main contactors and the second electric contacts, a second bypass line extending from the second line at a point disposed between the main contactors and the first electric contacts, and a third bypass line having a resistor and extending from the second line at a point disposed between the main contactors and the second electric contacts; a second relay having a first state that connects the first and third bypass line and a second state that connects the second and third bypass lines; wherein the system includes an initial state in which the main contactors are in the open state and the second relay is in the first state, wherein the system includes a startup state with the second relay in the second state and the main contactors are in the partially open state, wherein the system includes an operating state where the main contactors are in the closed state, and wherein the system includes a shutdown state with the main contactors in the open state and the second relay in the first state.

In one aspect, the main contactors are configured to make and break the connection along the first and second lines at each line independent of the other line. In another aspect, the main contactors are two separate relays.

In one aspect, the first electric contacts are attached to a battery. In one aspect, the second electric contacts are attached to electric vehicle components.

In one aspect, the resistor operates as a passive discharge unit in the initial state.

In one aspect, in the startup state, the circuit pre-charges components connected to the second electric contacts. In one aspect, in the operating state, the resistor is bypassed.

In one aspect, in the shutdown state, the resistor discharges energy present in the components connected to the second electric contacts.

In another aspect of the disclosure, a method for pre-charging and discharging a hazardous voltage direct current system includes providing a system in an initial state, wherein a first relay in the form of main contactors disposed on first and second lines connecting a first set of contacts and a second set of contacts are open, and wherein a second relay is in a first state connecting a first bypass line to a third bypass line having a resistor, such that the resistor is in series with the second contacts via the first and second lines; switching the second relay to a second state to connect a second bypass line to the third bypass line and making a connection on the first line between the first and second contacts and, in response thereto, pre-charging components connected to the second contacts from the first contacts via the resistor; in response to pre-charging, making a connection on the second line to connect the first contacts to the second contacts without the resistor; and opening the main contactors and switching the second relay to the first state and, in response thereto, discharging voltage from components connected to the second contacts.

In one aspect, the method includes charging the resistor when the second relay is in the second state and the main contactors are partially open, wherein the first contacts are connected to a battery.

In one aspect, the step of discharging the voltage from the components includes thermally discharging the components at the resistor.

In one aspect, the resistor is bypassed when the second relay is in the second state and the main contactors are closed.

In one aspect, the main contactors selectively makes and breaks a connection between the first contacts and the second contacts, wherein the first contacts are connected to a battery.

In another aspect of the disclosure, a system for pre-charging and discharging a hazardous voltage direct current system is provided comprising: a pair of first electric contacts connected to a pair of second electric contacts via an electric circuit, the first contacts configured for attachment to a battery and the second contacts configured for attachment to further components; a first relay in the form of main contactors disposed on the circuit; a second relay disposed on the circuit; a single resistor disposed on the circuit; wherein the system has a pre-charging state in which the first and second relays connect the single resistor between the first and second electrical contacts to pre-charge the further components; wherein the system has a discharge state in which the first and second relays connect the single resistor with the second electrical contacts to discharge the further components; wherein the system is configured to perform both a pre-charge and discharge with no additional resistors other than the single resistor and no additional relays other than the first and second relays.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a schematic circuit diagram illustrating a circuit for a pre-charging and voltage discharge unit, illustrating an initial state of the circuit;

FIG. 2 is a schematic circuit diagram illustrating a startup state of the circuit in which the resistor is charged by a battery;

FIG. 3 is a schematic circuit diagram illustrating an operating state in which the resistor is bypassed;

FIG. 4 is a schematic circuit diagram illustrating a shutdown state in which voltage is discharged into the resistor; and

FIG. 5 is a partial view of the circuit including additional resistors disposed on the circuit.

### DESCRIPTION OF THE ENABLING EMBODIMENT

Referring to FIG. 1, a system 10 for managing the voltage in an electric vehicle is provided. The electric vehicle includes a hazardous-voltage direct current (HVDC) system, where peak inrush current occurs in the HV circuit at power up, and high voltages are present in the HV circuit after switching off. The system includes a circuit 12 that is configured to both pre-charge the system 10 at power up and to discharge the hazardous voltage in the system 10 after switching off.

As is typical in electric vehicles, the system 10 includes a battery 13, the poles of which are connected to one end of the circuit 12 at KL1, which may also be referred to as first contacts. The system further includes further components connected to the opposite end of the circuit 12 at KL2, which may also be referred to as second contacts. The further components may include components of the electric vehicle including hazardous voltage components such as the electric motor, an inverter, DC/DC charger, and the like.

The circuit 12 includes main contactors (designated as RY1) that, when closed, transfers current from the battery 13 at KL1 to the further components at KL2. FIG. 1 illustrates an initial, inactive state, where the main contactors are open, such that current will not flow from the battery 13 at KL1 to the remainder of the system. RY1 may be implemented as two separate relays, or the second pole may have a separate smaller bridging relay, which could be integrated into RY2. The circuit 12 further includes a first line 14 shown at the bottom of the circuit diagram and extending from KL1 to KL2. The first line 14 includes a switch 14a coupled to the main contactors RY1, which is open in the initial state. The circuit also includes a second line 16 that extends from KL1 to KL2, similar to the first line 14. The second line 16 includes a switch 16a coupled to the main contactors RY1, which is open in the initial state. The main contactors RY1 controls the switches 14a and 16a to be either open or closed. When both switches 14a and 16a are closed, battery 13 will power components connected to KL2. In a pre-charge state, 14a is closed, and 16a is open, which may be referred to as a partially open state of the main contactors RY1.

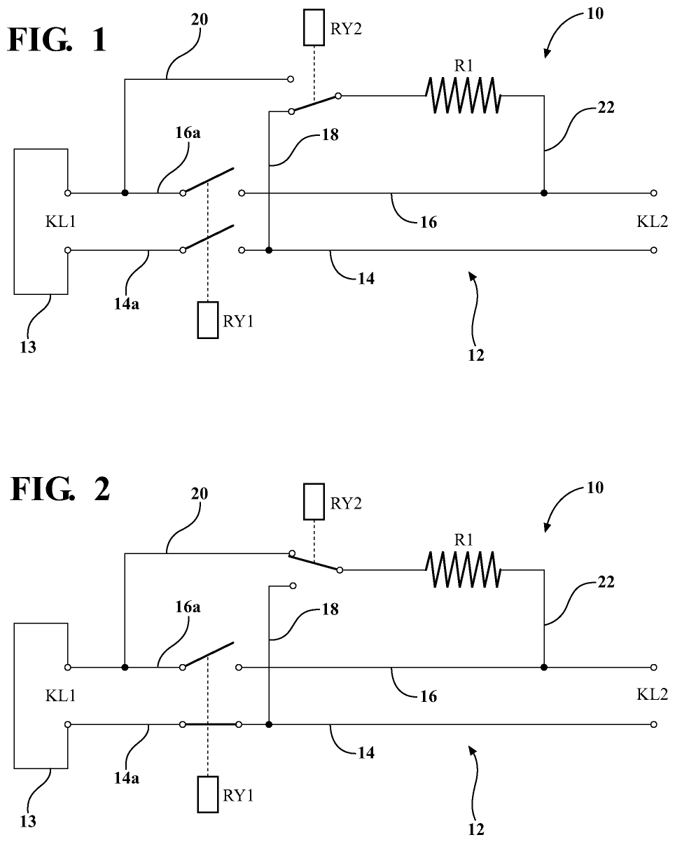

As shown throughout the figures, the main contactors are shown schematically as a single unit connected to each of the first and second lines 14, 16 to make and break the connection of the first and second lines 14, 16. However, the main contactors may be configured to independently make and break the connection at each of the lines 14, 16, and may be in the form of two separate contactors or relays for independent control of making and breaking the connection. For instance, in FIG. 2, the connection of the first line 14 is made, while the connection of the second line 16 is broken. For the purposes of this disclosure, the main contactors RY1 may also be referred to as a main relay or a first relay.

The circuit 12 further includes a set of bypass lines that can be connected or disconnected from the flow of current depending on the state of the circuit 12. A first bypass line 18 extends from the first line 14 toward a second relay RY2. A second bypass line 20 extends from the second line 16 toward the second relay RY2. A third bypass line 22 extends from the second relay RY2 to the second line 16.

The second relay RY2 operates as a switch to make or break the connection between the third bypass line 22 and one of the first bypass line 18 or the second bypass line 20. Thus, the second relay RY2 controls which pair of bypass lines are connected. In one state of the second relay RY2, shown in FIG. 2, the second bypass line 20 and the third bypass line 22 are connected via the second relay RY2 and the first bypass line 18 is disconnected at the second relay RY2, thereby creating a flow path parallel to the second line 16 and separating the first line 14 and the second line 16 from each other. The main contactors RY1 are disposed between the respective line contacts of the second line 16 with the second and third bypass lines 20 and 22.

In another state of the second relay RY2, the first bypass line 18 is connected to the third bypass line 22 via the second relay RY2, thereby creating a flow path between the first line 14 and the second line 16. The contact between the first bypass line 18 and the first line 14 is disposed between the main contactors RY1 and KL2. The contact between the third bypass line 22 and the second line 16 is also disposed between the main contactors RY1 and KL2. Thus, when the second relay RY2 connects the first bypass line 18 to the third bypass line 22, the first line 14 and the second line 16 are connected in the circuit, regardless of the state of the main contactors RY1.

FIG. 1 illustrates first and third bypass lines 18, 22 connected, but with the connection along lines 14 and 16 broken between KL1 and KL2.

The third bypass line 22, which as described above will connect the second line 16 to either the first line 14 or another contact point on the second line 16 depending on the state of the second relay RY2, includes a resistor R1. Thus, the second relay RY2 will control how the resistor R1 operates with the rest of the circuit 12. In one state of the relay RY1, as shown in FIG. 2, the resistor R1 is part of a flow path parallel to the second line 16 and disconnected from the first line 14. In another state, the resistor R1 is part of a flow path between the first line 14 and the second line 16, as shown in FIG. 1.

FIG. 1 illustrates the system 10 in its initial and inactive state. The main contactors RY1 are open, breaking the connection between KL1 and KL2 along lines 14, 16. In the initial state, RY2 is switched such that the first bypass line 18 and the third bypass line 22 are connected, and the second bypass line 20 is disconnected. Resistor R1 is therefore part of a flow path between the first line 14 and the second line 16, which are each connected to KL2. In this initial state, the resistor R1 functions as a passive discharge circuit with KL2 via relay RY2.

With reference to FIG. 2, in response to starting up the system 10, the second relay RY2 is switched, breaking the connection between the first bypass line 18 and the third bypass line 22, and making the connection between the second bypass line 20 and the third bypass line 22. In response to switching the second relay R2, the components connected to KL2 are pre-charged with resistor R1 as part of the flow path. Additionally, switch 14a is closed by main contactors RY1, while switch 16a remains open, such that connection is made along line 14 to complete the circuit between KL1 and KL2 and closing the loop for pre-charging. The circuit between KL1 and KL2 therefore includes the resistor R1. The main contactors RY1 may be considered to be in a partially open state in this state, with the connection along line 14 being made and the connection along line 16 being broken. However, it will be appreciated that with two separate relays or contactors controlling the making and breaking of these connections, reference to being partially open may be interpreted as one connection being made and another being broken.

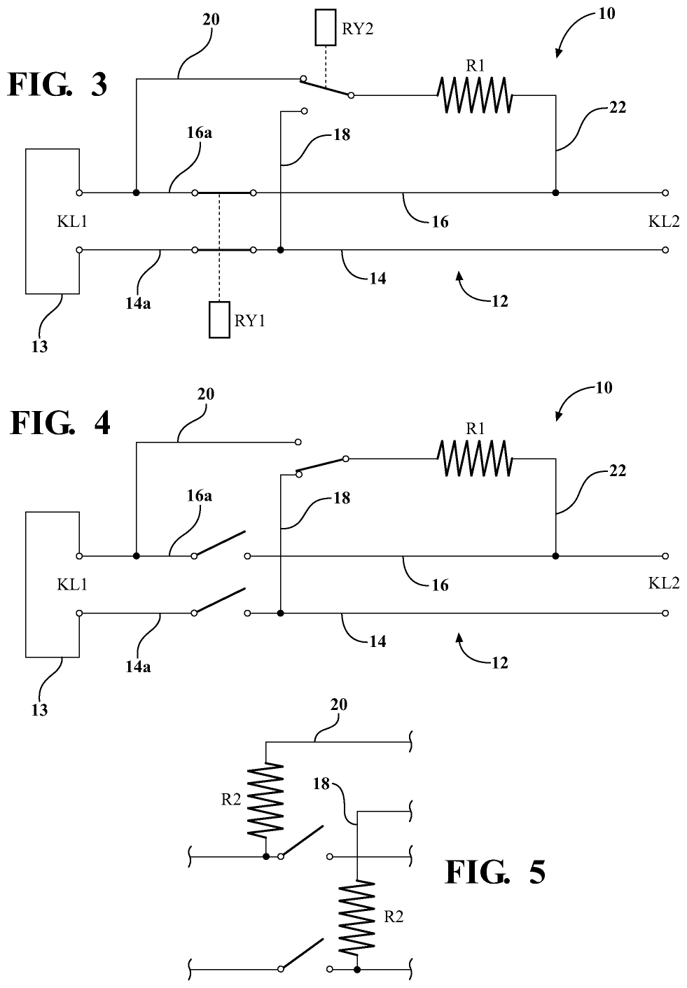

The pre-charging process is monitored and, after a pre-determined pre-charge threshold is reached, the pre-charging is complete. In response to completing the pre-charge, the main contactors RY1 are switched to a “closed” state, as shown in FIG. 3. In the closed state of the main contactors RY1, the first line 14 and the second line 16 each connect KL1 to KL2, and the system 10 is activated in its full operating mode. The second relay RY2 remains in its state connecting the second bypass line 20 and third bypass line 22, where the resistor R1 is connected in parallel to the second line 16. This parallel connection allows current to flow through the second line 16, bypassing the resistor R1.

With reference to FIG. 4, upon switching off the system, the main contactors RY1 are opened, breaking the connection along lines 14 and 16 between KL1 and KL2. Thus, the components connected to KL2 are no longer fully powered by KL1. The second relay RY2 is also switched at this point, making a connection between the first bypass line 18 and the third bypass line 22, thereby putting resistor R1 into a path between the first line 14 and the second line 16. The second bypass line 20 and KL1 are disconnected and in the same state as the initial state.

In this shutdown state, the energy present in the components connected to KL2 is discharged by resistor R1 thermally. A subsequent power up of the system 10 may occur later according to the process described above. In the event of a subsequent power up occurring shortly after shutdown, the pre-charging process may be completed more quickly due to the residual energy present in KL2.

Accordingly, the system 10 described above, having the two relays RY1 and RY2 and the single resistor R1 as a single functional unit disposed between KL1 and KL2 provides both pre-charging and discharging, without the need for a separate pre-charging unit and a separate discharge unit.

The resistor R1 has been described as a single resistor. However, in some cases, the pre-charge and discharge specifications for the resistor may be different. Thus, in another approach, an additional resistor R2 may be included on one or both of the first bypass line 18 and the second bypass line 20, thereby changing the total serial or parallel resistance depending on the switched state of the second relay RY2. FIG. 5 illustrates an example of additional resistors R2 on both lines 18 and 20. It will be appreciated that only one additional resistor R2 may be included, on either line 18 or 20. It will also be appreciated that reference to a resistor may also refer to a group of resistors disposed on a portion of a line to produce a desired resistance.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

1. A circuit for pre-charging and discharging a hazardous voltage direct current system, the circuit comprising:
a pair of first electric contacts connected to a pair of second electric contacts via first and second lines;
a first relay in the form of main contactors disposed on the first and second lines having an open state that breaks a connection between the first and second contacts and a closed state that makes the connection between the first and second contacts, and a partially open state that makes a connection along the first line and breaks a connection along the second line;
a first bypass line extending from the first line at a point disposed between the main contactors and the second electric contacts, a second bypass line extending from the second line at a point disposed between the main contactors and the first electric contacts, and a third bypass line having a resistor and extending from the second line at a point disposed between the main contactors and the second electric contacts;
a second relay having a first state that connects the first and third bypass line and a second state that connects the second and third bypass lines; and
wherein the system includes an initial state in which the main contactors are in the open state and the second relay is in the first state, wherein the system includes a startup state with the second relay in the second state and the main contactors are in the partially open state, wherein the system includes an operating state where the main contactors are in the closed state, and wherein the system includes a shutdown state with the main contactors are in the open state and the second relay in the first state.

2. The circuit of claim 1, wherein the main contactors are configured to make and break the connection along the first and second lines at each line independent of the other line.

3. The circuit of claim 2, wherein the main contactors are two separate relays.

4. The circuit of claim 1, wherein the first electric contacts are attached to a battery.

5. The circuit of claim 4, wherein the second electric contacts are attached to electric vehicle components.

6. The circuit of claim 1, wherein the resistor operates as a passive discharge unit in the initial state.

7. The circuit of claim 1, wherein, in the startup state, the circuit pre-charges components connected to the second electric contacts.

8. The circuit of claim 7, wherein, in the operating state, the resistor is bypassed.

9. The circuit of claim 8, wherein, in the shutdown state, the resistor discharges energy present in the components connected to the second electric contacts.

10. A method for pre-charging and discharging a hazardous voltage direct current system, the method comprising:
providing the system in an initial state, wherein a first relay in the form of main contactors disposed on first and second lines connecting a first set of contacts and a second set of contacts are open, and wherein a second relay is in a first state connecting a first bypass line to a third bypass line having a resistor, such that the resistor is in series with the second contacts via the first and second lines;
switching the second relay to a second state to connect a second bypass line to the third bypass line and making a connection on the first line between the first and second contacts and, in response thereto, pre-charging components connected to the second contacts from the first contacts via the resistor;
in response to pre-charging, making a connection on the second line to connect the first contacts to the second contacts without the resistor; and
opening the main contactors and switching the second relay to the first state and, in response thereto, discharging voltage from components connected to the second contacts.

11. The method of claim 10 further comprising charging the resistor when the second relay is in the second state and the main contactors are partially open, wherein the first contacts are connected to a battery.

12. The method of claim 10, wherein the step of discharging the voltage from the components includes thermally discharging the components at the resistor.

13. The method of claim 10, wherein the resistor is bypassed when the second relay is in the second state and the main contactors are closed.

14. The method of claim 10, wherein the main contactors selectively makes and breaks a connection between the first contacts and the second contacts, wherein the first contacts are connected to a battery.

15. A system for pre-charging and discharging a hazardous voltage direct current system, the system comprising:
a pair of first electric contacts connected to a pair of second electric contacts via an electric circuit, the first contacts configured for attachment to a battery and the second contacts configured for attachment to further components;
a first relay in the form of main contactors disposed on the circuit;
a second relay disposed on the circuit;
a single resistor disposed on the circuit;
wherein the system has a pre-charging state in which the main contactors and second relay connect the single resistor between the first and second electrical contacts to pre-charge the further components; and
wherein the system has a discharge state in which the main contactors and second relay connect the single resistor with the second electrical contacts to discharge the further components.

16. The system of claim 15, wherein the system is configured to perform both a pre-charge and discharge with no additional resistors other than the single resistor and no additional relays other than the main contactors and second relay.

17. The system of claim 15, wherein in the discharge state the main contactors and the second relay disconnect the first electrical contacts from the single resistor.

18. The system of claim 15 wherein the single resistor is the only resistor within the system connected to the second electrical contacts in the pre-charging state and the discharging state.

19. The system of claim 1, further comprising a further resistor disposed on at least one of the first bypass line or the second bypass line.

20. The method of claim 10, further comprising connecting the first and second electrical contacts via the first and second lines and the connectors of the first relay and, in response thereto, bypassing the resistor regardless of the state of the second relay.
